(19) United States
(12) Patent Application Publication
(10) Pub. No.: US 2023/0048506 A1
(43) Pub. Date: Feb. 16, 2023

(54) EDIBLE PET CHEW TOY AND METHOD AND SYSTEM FOR USE

(71) Applicant: COOLHOUSE SOURCING LLC, Minneapolis, MN (US)

(72) Inventors: Andrew Joel PONTE, Springdale, AZ (US); Lee Wayne MAYBERRY, Arvada, CO (US)

(21) Appl. No.: 17/971,501

(22) Filed: Oct. 21, 2022

Related U.S. Application Data
(63) Continuation of application No. PCT/US2021/028316, filed on Apr. 21, 2021.
(60) Provisional application No. 63/013,103, filed on Apr. 21, 2020.

(51) Int. Cl. A23K 40/30; A23K 10/26; A23K 50/42; A23K 10/30; A01K 15/02

(52) U.S. Cl. CPC A23K 40/30; A23K 10/26; A23K 50/42; A23K 10/30; A01K 15/026

(57) ABSTRACT

An edible dog chew toy includes: (i) a tough chewable material (e.g., a natural rawhide or a synthetic “rawhide-type” material); and (ii) one or more active ingredients that are useful for promoting a calming effect on a dog. The toy is extremely appetizing for dogs, and the smell and taste of the toy (or a treat member provided therein) constantly entices the dog to chew the toy over a substantial portion of the life of the toy.

### CROSS REFERENCE TO RELATED APPLICATIONS

This application is a continuation under 35 U.S.C. § 111 of International Application No. PCT/US2021/028316 filed Apr. 21, 2021, which claims priority under 35 U.S.C. § 119 to U.S. Provisional Application No. 63/013,103 filed Apr. 21, 2020, the disclosures of both of which are incorporated herein by reference.

### BACKGROUND

Companion animals are often given toys or other devices to keep them interested or occupied. The devices can contain a variety of active or passive stimuli to keep the animals interested in the device. For example, a dog toy might have a squeaker embedded in the device that emits a noise when the dog steps on or bites down on the device. This noise can cause the dog to play with the device for a longer period of time than a similar device without the noise emitter. The stimuli can be mechanical, organoleptic, tactile (e.g., bumpy surfaces that massage the animal's mouth), electronic (noise, vibration), etc. Particularly effective occupying toys contain an edible and tasty treat.

One popular type of “occupying” device for dogs contains an embedded treat. An example of such a device is the KONG Classic device from the Kong Company. See https://kongcompany.com/kong-classic. Typically, the dog's owner “stuffs” a large cavity of the rubber device with kibble, peanut butter, or another ingestible treat or paste, and the dog shakes, rattles, bites, moves or otherwise uses the device to dislodge the treat from the device. Unfortunately, these devices do not reliably facilitate the predictable, gradual, or prolonged ingestion of the treat by a dog. Instead, they learn to throw, shake or toss the devices and this type of active usage is not a calming activity for the animal.

One product on the market is sold under the name Nylabone Romp'n Chomp™ Super Treat Holder Dog Chew Toy by Nylabone. See www.nylabone.com/products/product-type/treat-toys/romp-n-chomp-treat-holder-and-treat. This treat holder is designed with a rectangular groove along one side of the device. The groove (with a slightly open tapered square profile) is adapted to receive a somewhat hard treat that loosely “snaps” into the groove. This design has the advantage that the treat is positioned to be easily lickable by the dog. While licking the treat should be a fairly reliable way to prolong the ingestion of a treat, the treat in the Nylabone device is only loosely held in place in the groove by two rigid tabs at the midpoint of the device. Unfortunately, a dog can easily learn to dislodge the treat from the device by dropping the loaded device onto the floor. Once dislodged, the treat then can be quickly devoured by the dog. Consequently, this toy is not an acceptable way to reliably prolong the ingestion period of the treat.

Rawhide-type treats (which may be made using either real rawhide materials or a synthetic material that mimics rawhide) are alternative devices that can be used to occupy a dog. The devices also can be sized so as to create a fairly reliable and prolonged ingestion period. Rawhide has no inherent flavor and thus may lose a dog's interest after only a short chew time. To overcome the lack of flavor and taste of rawhide, manufacturers have attempted to add flavor to the pet chew by adding jerky, natural flavors or even pig hide in addition to the rawhide. Manufacturers have also added a coating or baste that include substances such as glucosamine HCL, Vitamins or calcium.

### SUMMARY

The toys discussed above do not include active ingredients that treat one or more condition such as sleeplessness, anxiety, pain or inflammation and where a prolonged and reliable ingestion period of the active ingredient is desired or critical. Moreover, some of the above devices do not reliably provide a prolonged ingestion period that calmly occupies a dog. Rather, they induce activity in the dog as it tries to knock the treat(s) free of the device for quick ingestion. From the foregoing, it will be appreciated that what is needed in the art is a device that facilitates the predictable and prolonged ingestion of an active ingredient by a dog. Such apparatuses, systems or methods are disclosed and claimed herein.

In one embodiment, the present invention provides an edible dog chew toy that includes a tough chewable material and one or more active ingredients that are useful for promoting a calming effect on a dog. The toy preferably has an appealing taste and scent for the dog that last throughout substantially the entire chewing life of the chew toy.

In another embodiment, the present invention provides a method of calming a dog that includes the step of providing the dog with the disclosed chew toy. The method may also include the step of first providing the dog with a bolus of a calming composition that is quickly ingested by the dog.

The edible toys preferably include a tough chewable material such as a natural rawhide or a synthetic rawhide-type material. The toy also preferably includes one or more active ingredients that are useful for promoting a calming effect on a dog, such as theanine,

Relora, SAMe, GABA, ashwagandha, tryptophan, turmeric, Boswellia serrata, and ginseng. The toy also preferably includes one or more pharmacologically active, but non-psychoactive, cannabinoids.

Various aspects of the instant disclosure are directed to apparatuses, systems or methods that facilitate the prolonged ingestion of a treat containing an active ingredient into a dog. As will be apparent from the more detailed discussion that follows, one or more these aspects are directed to overcoming issues including but not limited to those mentioned above. The above summary is not intended to describe each disclosed embodiment or every implementation. The description that follows more particularly exemplifies illustrative embodiments. The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

FIG. 1 is a front elevational view of a prior art rawhide chew toy.

FIG. 2 is a front elevational view of a chew toy.

FIG. 3 is a cross-sectional view of a chew toy taken through line 3-3 of FIG. 2

FIG. 4 is a perspective view of a chew toy.

FIG. 5 is a perspective view of a chew toy.

FIG. 6 is a top plan view of the toy of FIG. 2 in an intermediate stage of manufacture.

FIG. 7 is a cross-sectional view of another embodiment of the disclosed chew toy.

FIG. 8 is a perspective view showing a single sheet of a plant-based starch material forming an edible pet chew.

FIG. 9 is a perspective view of the edible pet chew shown in FIG. 8.

FIG. 10 shows another embodiment having two knotted ends to simulate a bone using the single sheet shown in FIG. 8.

FIG. 11 is a perspective view showing a single co-extruded sheet of a plant-based starch material forming an edible pet chew.

FIG. 12 is a perspective view of the edible pet chew shown in FIG. 11.

FIG. 13 shows another embodiment having two knotted ends to simulate a bone using the single sheet shown in FIG. 11.

FIG. 14 is a perspective view showing a single sheet of a plant-based starch material with embedded treat chunks interspersed throughout forming an edible pet chew.

FIG. 15 is a perspective view of the edible pet chew shown in FIG. 14.

FIG. 16 shows another embodiment having two knotted ends to simulate a bone using the single sheet shown in FIG. 14.

### DETAILED DESCRIPTION

Unless otherwise specified, the following terms as used herein have the meanings provided below.

Terms such as “a,” “an,” “the,” “at least one,” and “one or more” are used interchangeably. Thus, for example, a composition that comprises “an” ingredient can be interpreted to mean that the composition includes “one or more” ingredients.

The term “active ingredient” when used in connection with a chemical in a chew administered to or to be administered to an animal means that such chemical is bioactive in such animal.

The terms “comprises,” “includes” and variations thereof do not have a limiting meaning where these terms appear in the description and claims.

The term “extract” or “ground portion” when used in connection with a medicinal plant, tree bark or root refers to a chemical or mixture of chemicals obtained from such plant by any suitable purification or concentration technique (e.g., by expression, absorption, maceration or distillation), and shall also include a synthesized (including fermented or otherwise biosynthesized) chemical or mixture of chemicals having the same or substantially pharmacologically equivalent structures.

The term “non-prescription” when used in connection with an active ingredient administered to or to be administered to an animal means an active ingredient whose purchase or use do not require a prescription from a licensed veterinarian in the applicable jurisdiction where such administration occurs or will occur.

The term “non-psychoactive” when used in connection with an active ingredient administered to or to be administered to an animal means that the ingredient does not produce a significant effect (such as changes in perception or behavior) on the mind or mental processes of such animal. By way of example, a person having ordinary skill in the art would regard CBD as non-psychoactive and THC as psychoactive.

The term “over-the-counter cold remedies” refers to a non-prescription retail product whose primary labelled use is for the treatment of the common cold symptoms.

The term “over-the-counter allergy treatments” refers to a non-prescription retail product whose primary labelled use is for the treatment of allergy symptoms.

The term “pharmacologically active” when used in connection with an active ingredient administered to or to be administered to an animal means that such chemical has beneficial bioactive effects.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

In one embodiment, the disclosed system and method includes an edible chew toy (hereinafter “chew toy” or “chew” or “pet chew”) that includes:
a tough chewable material (e.g., a natural rawhide or a synthetic “rawhide-type” material, collectively referred to as “rawhide”); and
(ii) one or more active ingredients that are useful for promoting a calming effect on a dog; and wherein
(iii) the edible chew toy is extremely appetizing for dogs, and the smell and taste of the toy (or a treat member provided therein) constantly entices the dog to chew the toy (e.g., entices the dog to chew the toy over a substantial portion of the life of the toy) over a prolonged period.

The edible chew toy comprises one or more active ingredients that are useful for promoting a calming effect on the dog, including the active ingredients as are described in copending U. S. Provisional. Application No. 63/13,158 filed Apr. 21, 2020 and in copending International Application No. (Attorney Docket No. 5225.01WO01) filed even date herewith, both of which are entitled COMPOSITION, ARTICLE AND METHOD FOR

AFFECTING A MAMMAL and both of which are incorporated herein by reference. Exemplary active ingredients that are useful for promoting a calming effect on a dog include: (i) active agents (such as theanine, Relora, SAMe, GABA, ashwagandha, tryptophan, turmeric, Boswellia serrata, panax ginseng, Methylsulfonylmethane, 5-HTP, etc.), other botanicals that facilitate sleep and relaxation (such as Valerian root, Chamomile, Lemon balm, Passion flower, Kavakava, Tulsi-Holy basil (Ocimum tenuiflorum)) and cannabinoids (such as CBD, CBN, etc.). Exemplary dosages of such active ingredients are further described in the aforementioned patent application.

Exemplary active agents for use in the present invention include:

amino acid-based ingredients that have central nervous system effects;

receptor modulators for acetylcholinesterase, butyrylcholinesterase, 5-HT1 or 5-HT2;

monoamine metabolizers;

extracts of certain medicinal plants, tree barks and roots; and

other pharmacologically active chemicals and agents.

Exemplary cannabinoids for use in the present invention include pharmacologically active, but preferably non-psychoactive, cannabinoids. Presently preferred cannabinoids include cannabidiol (CBD), cannabinol (CBN), cannabigerol (CBG), cannabichromene (CBC), cannabielsoin (CBE), cannabicyclol (CBL), cannabicitran (CBT), cannabichromanone (CBCN), cannabinodiol (CBND) and related compounds. Presently most preferred cannabinoids include CBD, CBN and CBG.

Exemplary toys are sized to meet the needs of different sized dogs. It is common to prepare suitable dosages for small dogs (5 to 25 pounds; 2.3 to 11.3 kg), medium dogs (26 to 50 pounds; 11.8 to 22.7 kg) and large dogs (51 to 100 pounds; 23.1 to 45.4 kg). Typically, the dosage of an ingredient will target the midpoint of the lower and upper ends of the weights for the particular size of dog. For example, a medium sized dog has an 11.8 to 22.7 kg size range, with a midpoint of 17.2 kg. When expressing suitable and preferred dosages of an ingredient in this document, it will generally be done as a mg/kg figure.

If provided with one or more active ingredients, the ingredients are provided in the toy such that the dosage of the ingredient is appropriate for the sized dog using the toy. Typical and exemplary dosages of active ingredients are described in the aforementioned co-pending U. S. Pat. Application.

In preferred embodiments, the edible chew toy is sized to provide a typical dog with a prolonged chew time period. Typically, the chew toy is provided in a small, a medium and a large size. The prolonged chew time period is preferably at least one hour for the average dog, more preferably at least two hours, and even more preferably the chew toy lasts at least three hours from start to finish. This is in contract with typical “hard treat” such as milk bone treats, which are generally completely consumed by the dog in only a few minutes, or less than 15 minutes, or less than 30 minutes.

Typical optimal dosages of various active ingredients are listed below for typical small, medium and large dogs. Suitable toys can include one or more of the active ingredients.

Mixtures of two or more are preferred as is discussed in the co-pending patent application.

| | Small dog | Med. Dog | Large dog |
|---|---|---|---|
| Ingredient | mg | mg | mg |
| Broad spectrum hemp extract | 6 | 14 | 28 |
| CBD | 4 | 10 | 20 |
| CBN | 2 | 4 | 8 |
| CBG | 2 | 4 | 8 |
| Relora | 69 | 175 | 345 |
| SAMe | 79 | 200 | 395 |
| Trytophan | 71 | 181 | 357 |
| GABA | 39 | 100 | 197 |
| Theanine | 20 | 50 | 99 |
| Ashwagandha | 12 | 30 | 59 |
| Turmeric | 143 | 362 | 714 |
| Boswellia serrata | 41 | 103 | 204 |
| Methylsulfonylmethane | 49 | 123 | 243 |
| Panax ginseng | 29 | 74 | 146 |
| 5-HTP | 32 | 80 | 158 |

It is understood that the above optimal dosages are approximate and can be adjusted as needed. Preferred dosages are from 20 to 300%, more preferably from 35 to 200% , and most preferably from 50 to 150% of the optimal dose.

When used to treat a particular issue (e.g., separation anxiety), it may be desirable to administer a first dosage of the active ingredients in a bolus (such as from a soft chew, melt or topper) and then provide the dog with a second dosage that can be consumed over a prolonged period by the dog's consumption of the edible chew toy. In the case of a separation anxiety treatment, the first dose will act to quickly calm the dog, while the toy (and included second dosage) will continue and prolong the calming effect.

In one embodiment, the edible chew toy comprises a tough chewable material and a tasty treat member (hereinafter the “treat”). The treat member is preferably contained in, wrapped in, or otherwise protected by the tough chewable material in a manner which provides the chew toy with an appealing taste and scent for the dog throughout substantially the entire chewing process of the chew toy. The rigidity and other properties of the tough chewable material satisfies the dog's inherent urge to chew and channels that urge in a healthy direction. The toy further comprises one or more active ingredients that that are useful for promoting a calming effect on a dog. The active ingredients may be provided with or included in the tough chewable material; or they may be provided with or included in the treat member. The treat member may be made using any suitable composition that can be contained in, wrapped in, or otherwise protected by the toy.

In some preferred embodiments, the proportion of the rawhide to treat member by weight will be between the range of 5:1 and 15:1, and more specifically, approximately 10:1. However, it is recognized that higher or lower ratios of rawhide to treat member may be used.

In one embodiment, the treat member is a tasty coating that is applied to a rawhide material prior to wrapping the rawhide. The coating comprises, in addition to the active ingredients, flavors to entice the dog, and suitable binders or carriers to facilitate the coating operation or facilitate the coating's prolonged retention on the toy's inner surfaces.

In another embodiment, the active ingredients and the flavors to entice the dog are mixed together with suitable ingredients to manufacture the tough chewable material, and the chewable material is then shaped (e.g., rolled or knotted or both) into an edible toy.

In another embodiment, the treat member is a jerky composition that contains one or more active ingredients in addition to the typical jerky ingredients (e.g., flavors, meats, meat products, etc.). The term “jerky,” as used herein, is defined as including traditional and kippered jerkies. “Traditional jerky” typically consists of beef, chicken, turkey, fish, or another animal meat which is cut into strips. The sliced meat may be flavored using spices or a marinade and is dried via a smoker or another manner. “Kippered jerky” includes chopped pieces of meat, chicken, turkey, fish, meat substitute, etc., which is mixed together with spices and fillers. The mixture is forced through a press or extruder, typically into a flat form, and is then smoked or dried in another manner. We have discovered that either type of jerky can be modified using the active ingredients to make a tasty jerky that contains the active ingredient(s). In that manner, the prolonged consumption of the rawhide toy will simultaneously cause the enclosed jerky to be consumed, and thereby cause the included active ingredient(s) to be consumed over approximately the same prolonged period.

In one embodiment, the treat member will be a “traditional jerky,” prepared in conformance with USDA regulations requiring certification of water quality, cooking and heating procedures. However, “kippered jerky” may be used in lieu of the traditional jerky. Prior to superimposing a jerky sheet or sheets on the rawhide, a mold inhibiting additive, for example potassium sorbate, is sprayed on the jerky to provide protection from mold growth on the jerky during the drying process of the moist rawhide. The rawhide and jerky may then be manipulated, e.g., folded or rolled. For example, the rawhide and jerky can be rolled into a cylinder and, if desired, the ends can be knotted manually or mechanically. The rawhide and jerky could also be folded, either manually or mechanically. The chew toy is then dried thoroughly in any conventional manner, e.g., it may be sun dried approximately four to seven days. The chew toy will become more rigid after it has dried and will maintain its wrapped, e.g., rolled or folded shape. After it has been dried, the chew toy is preferably air packed or shrink wrapped to prevent the jerky from spoiling.

As chewing rawhide for extended periods of time tends to reduce plaque and tartar on dogs' teeth, it is expected that the edible chew toys will provide enhanced reduction of plaque and tartar because the dogs will tend to gnaw on the chew toys for longer periods of time.

In one embodiment, an improved edible pet chew is provided that contains one or more active ingredients that are useful for promoting a calming effect on a dog and has a single sheet of hardened and chewable plant-based material that is initially malleable for folding, rolling or flexing into a final shape. In one embodiment, the single sheet of plant-based material comprises an extrudable starch composition.

The one or more active ingredients may be:

mixed into the plant-based material; or

provided in a coating applied to a sheet of the plant-based material; or

provided in a separate layer wrapped with the sheet of the plant-based material; or

provided as discrete strips or chunks of an edible material; or

combinations of the above.

In one embodiment, the single sheet contains chunks of a cured or dried animal flesh material embedded therein. The single sheet may be rolled and knotted at each end to form the final shape of the pet chew or rolled to form a cylindrical roll.

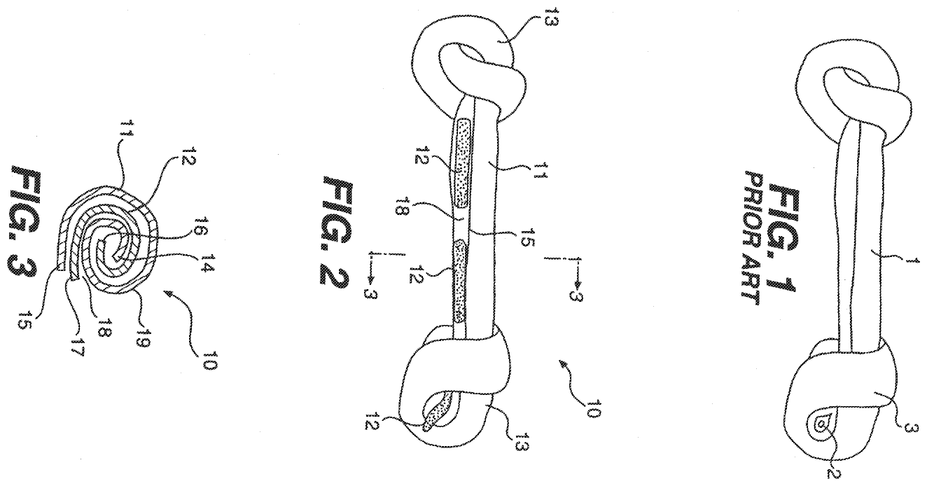

FIG. 1 is a front elevational view of a prior art rawhide chew toy that includes a rolled and knotted sheet of rawhide. To make the bone, a sheet of wet rawhide is rolled into a cylindrical form 1, and while it is still wet, at least one of the ends 2 is knotted 3 to simulate an animal joint.

As shown in FIGS. 2 and 3, chew toy 10 includes a rawhide sheet 11 and at least one treat member 12 which are rolled and preferably, as shown, knotted at both its ends 13. The treat member 12 may be a separate sheet as shown in FIG. 3 or a coating on at least one major surface, preferably an inner major surface when the toy is rolled and knotted, of the rawhide. In the case of a synthetic rawhide the treat member may be integral with the synthetic rawhide material. For example, the active ingredients and other treat ingredients may be mixed together with the synthetic raw hide ingredients and formed as an integral part thereof.

As best shown in FIG. 3, the rawhide sheet 11 has a first edge or end 14 toward the center of the rolled chew toy 10, and an opposing second edge or end 15 at the outer periphery of rolled chew toy 10. Similarly, the treat member 12 has a first edge or end 16 toward the center of the rolled chew toy 10 and an opposing second edge or end 17 at or near the outer periphery of rolled chew toy 10. It is preferred that the end 17 of treat member 12 extends through a seam 18 formed in the outer layer 19 of chew toy 10 created by the rolling or folding of the rawhide sheet 11.

The relationship between the rawhide sheet and treat member is such that the benefits of the treat and the rawhide are maximized throughout the entire chewing process of the chew toy. Dogs are highly attracted to the scent and taste of the treat member (which may be a sheet as shown in FIG. 3 or a coating on at least one major surface (preferably an inner major surface) of the rawhide). As previously described, chewing rawhide for extended periods of time provides a healthy channel to satisfy a dog's instinctive need to chew. Chew toy 10 preferably provides treat member 12 at or near the periphery of the chew toy 10 at all times while the dog is gnawing on toy 10 to enable the odor and taste sensations of the treat to always be present and fresh to the dog.

For example, as shown in FIG. 3, one end 17 of the treat member 12 is exposed near the end 15 of rawhide sheet 11 and another portion of the treat member 12 is located immediately below the chew toy's outer layer 19 of rawhide. This provides an initial and appealing odor to attract the dog to the chew toy before it starts to chew and provides taste and scent attraction as the dogs begins to chew. As the dog continues to chew for extended periods of time, the rawhide being chewed, viz., most likely the outer layer, slowly disintegrates and is digested by the dog with portions of the treat member immediately thereunder. After the outer layer of rawhide and the treat member thereunder is digested, the chew toy continues to provide a fresh attractive scent and taste as unchewed treat member is located under the second layer of rawhide and at or exposed adjacent the outer edge of the remaining rolled rawhide. Additionally, as there is a substantial amount of rolled rawhide resisting the simple consumption of the treat member, the dog will have to gnaw or chew the rawhide to get at small sections of the treat member. Thus, the dog's need to chew will be satisfied and successfully channeled in a healthy manner by chewing the rawhide, and the dog will continue to chew the rawhide (and thereby consume the active ingredient(s)) for extended periods of time due to the odor and taste provided by the treat member.

Further, in some preferred embodiments, the treat member 12 is positioned such that a small amount, e.g., 10 to 25 mm, of the treat member 12 projects out of the longitudinal seam 18 in the rawhide outer layer 19. The exposed treat member makes the chew toy initially more attractive to the dog from an odor and taste standpoint, and provides an immediate starting point for chewing.

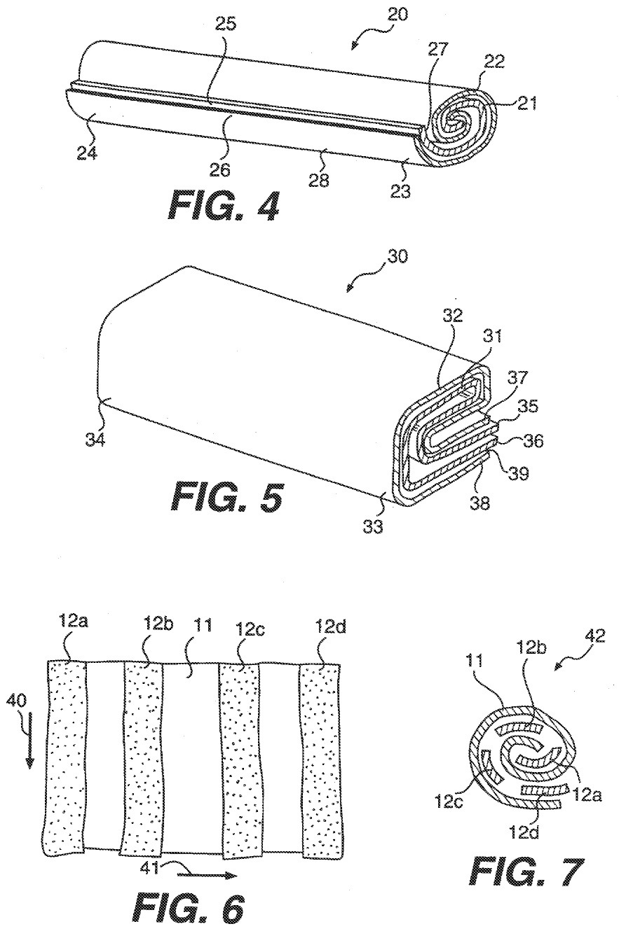

Another embodiment is shown in FIG. 4. Chew toy 20 is similar to chew toy 10 of FIGS. 2 and 3 in that one or more sheets of treat member 21 are rolled with a sheet of rawhide 22. However, unlike the knotted ends of chew toy 10 chew toy 20 has unknotted ends 23 and 24. This configuration may be preferred to some dogs. In a preferred variation of this embodiment, the treat member 21 is positioned such that a small amount, e.g., 10 to 25 mm, at the end 25 of the treat member 21 projects out of the seam 27 in the outer rawhide layer 28 adjacent the outer edge 26 of the rawhide sheet 22. As described with respect to the previous embodiment, the exposed treat member makes chew toy 20 initially more attractive to the dog from an odor and taste standpoint, and provides an immediate starting point for chewing.

Chew toy 30, as shown in FIG. 5, includes one or more sheets of treat member 31 wrapped within a sheet of rawhide 32. However, unlike the being rolled like chew toys 10 or 20, chew toy 30 is folded one or more times upon itself, in lieu of being rolled. While depicted in FIG. 5 as having unknotted ends 33 and 34, it is recognized that the ends may be knotted if the length of the folded chew toy is sufficient to do so. Further, in one preferred variation of this embodiment, the treat member 31 is positioned such that a small amount, e.g., 25 mm, at both ends 35 and 36 of the treat member 31 extends through a seam 39 in the outer rawhide layer, viz., it projects past the ends 37 and 38 of the rawhide sheet 32 when folded over. While it is apparent that chew toy 30 in FIG. 5 was folded onto itself two times, it is also recognized that chew toys may be formed by folding it once or more than two times.

Chew toys 10, 20, and 30, are preferably formed by wrapping, e.g., folding or rolling, one or more members consisting of an active ingredient containing treat in a rawhide sheet. For example, a single sheet of treat member may be used which is of substantially the same size as the rawhide. In the alternative, a plurality of spaced or adjacent treat members may be used. For example, to form the chew toy 10 of FIGS. 2 and 3, a plurality of separate treat members 12a-12d, are superimposed across a sheet of rawhide 11 as shown in FIG. 6. The rawhide sheet 11 and treat members 12a-12d could then be rolled in the direction of arrow 40 and knotted at its ends. This creates longitudinally separated exposed sections of treat member 12 as shown in FIG. 2. In the alternative, treat member sheets may be placed immediately adjacent to one another to form a longitudinally continuous exposed section of treat member as depicted in chew toy 20 of FIG. 4.

In an alternative embodiment, the treat member may be wrapped in the rawhide in a direction lateral to the jerky members. For example, the arrangement of jerky sheets and rawhide shown FIG. 6, could be rolled in the direction of arrow 41 to form a chew toy 42 substantially as shown in FIG. 7. This creates a chew toy 42 with the treat members 12a-12d angularly spaced within the rawhide sheet 11. However, it is noted that regardless of wrapping direction, a single sheet of treat member may be used, and it need not be of substantially similar size to the rawhide sheet. Further, it is also possible to wrap rawhide around treat members which are not in a sheet form, e.g., having more of a cylindrical form, and still obtain a chew toy experiencing the benefits of treat member in combination with rawhide.

To manufacture chew toys 10, 20, and 30, rawhide is cut into rectangles having a predetermined size depending upon the desired length and thickness of the chew toy. For example, in manufacturing chew toy 10 the length of the rectangles is equal to the nominal length of the rolled center portion plus the additional length on both ends sufficient to tie a knot at both ends of the toy 10. Additionally, the width of the rectangle is preferably sufficient for the rawhide to be rolled between 1.5 and 2 times over itself. The thickness of the rawhide may vary as a function of the length of the chew toy to provide it with sufficient and desired structural stability and stiffness. In one preferred embodiment, the thickness of the rawhide is approximately 3 mm. However, it is recognized that the length, width, and thickness of the rawhide may vary as desired to obtain chew toys of different shapes, configurations, and stiffnesses.

In one embodiment, the rawhide is a standard international grade natural rawhide taken from the second layer cut of cow or buffalo hide. The rawhide may be tanned and may further be processed as desired by dehairing, liming, etc., as is well known in the art. When natural rawhide is used, the cut rawhide sheets are preferably soaked in a solution including hydrogen peroxide and chlorine to make it sufficiently malleable to manipulate as desired, e.g., fold, roll or knot. Each rawhide sheet is laid flat and one or more treat members or sheets are superimposed or laid on the cut rawhide sheet in a generally superimposed relationship. For example, as shown in FIG. 6, four treat member sheets 12a-12d may be placed on a rawhide sheet 11. Depending upon the desired configuration, the treat member may be oriented in a direction along the long or the short side of the rawhide and wrapped in the desired direction. In a preferred embodiment, the jerky sheets are preferably about 3 mm in thickness. However, it is recognized that the rawhide sheets may be thicker or thinner as desired.

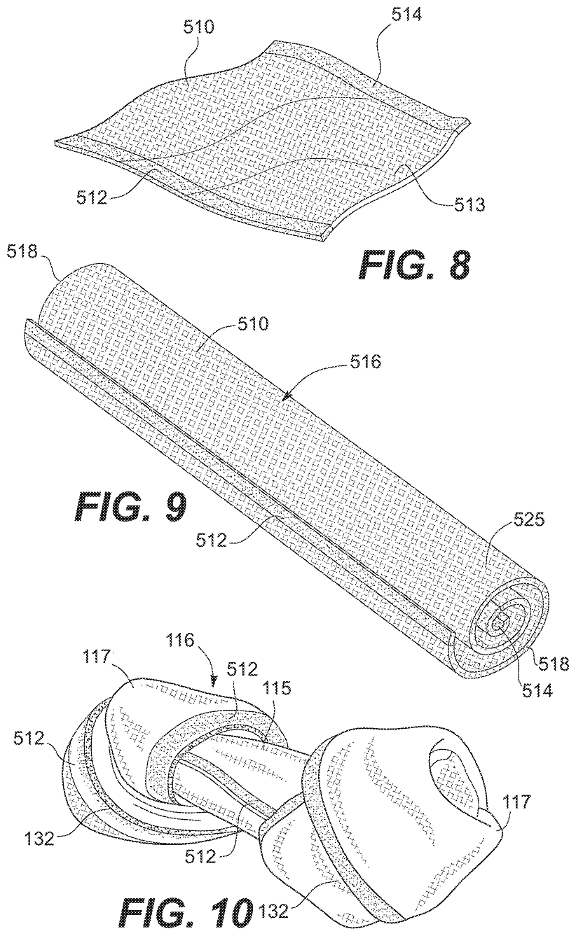

FIG. 8 illustrates a single sheet 510 of a plant-based composition, for example a wheat starch mixed with a gelatin or other binder (e.g., glycerin). The single sheet 510 can be formed by extrusion, rolling, pressing or other process so that it is flat and thin. Its thickness preferably ranges from 2 mm to 5 mm. The sheet has width and length dimensions preferably ranging from 10 cm to 20 cm each. The term “plant based” means material having substantially over 50% of plant material. The gelatin may be a small percentage by weight, for example 5%, to provide sufficient malleability, moldability, extrudability, and formability as set forth in further detail below. Other plant materials may be substituted for the above mentioned materials as long as the material is a cohesive material that can be rolled and formed in a malleable state and eventually hardened by heat or drying into a hard but chewable matter for use by a carnivorous pet.

The single sheet 510 has a first edge section 512 and a second edge section 514 that may have a visually distinctive appearance, for example, a different color or texture from the remaining mid-section 513 of the sheet 510. In addition, or alternatively, the edges 512, 514 may have a different flavor from the remaining mid-section 513. In one embodiment, the edge sections 512, 514 may be colored red to simulate a beef jerky. The edge sections 512, 514 may also have a meat or other attractive scent or flavor infused or otherwise added to them. The flavor additive may be either artificial or real. The edge sections 512, 514 may also have one or more active ingredients infused or otherwise added to them.

The single sheet 510 as shown in FIG. 8 is then rolled up as shown in FIG. 9 to form a cylinder roll shaped edible pet chew 516. The pet chew 516 has end sections 525 that appear from an end view to have a spiral shape 518. The edge section 514 is near the center or interior of the pet chew 516. The edge section 512 of single sheet 510 is positioned at the exterior side of pet chew 516 and provides an illusion that a piece of beef jerky extends out of a roll. The cylinder-shaped pet chew 516 is then allowed to dry to harden the composition forming the single sheet 510.

As shown in FIG. 10, an alternate shaped pet chew 116 can be formed to more closely simulate an elongated bone with an elongated middle section 115 also referred to as a diaphysis and opposite simulated epiphyses 117 formed by knots 132 tied at each end section 525 of the cylinder shaped assembly 516 as shown in FIG. 9 before it's hardened. The alternately shaped edible pet chew 116 still has the same flavored or colored edge section 512, positioned at an outer portion of the epiphyses 117 as well as at the exterior side of the elongated middle section 115 to stimulate a beef jerky strip extending out of the bone. Edge section 514 is positioned to the interior of the pet chew 116 but can be detected by the dog's keen sense of smell to maintain the dog's interest in the pet chew.

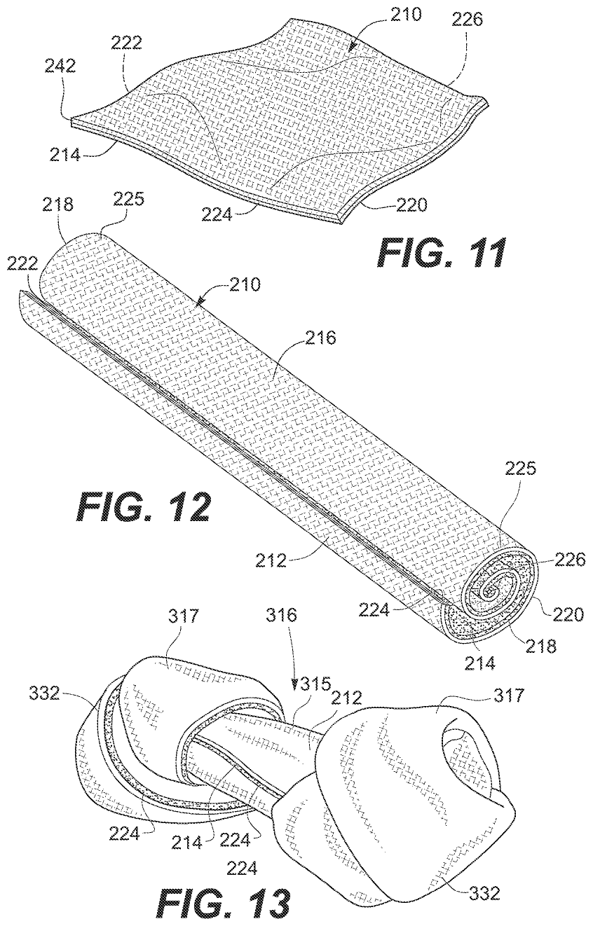

Another alternate embodiment of the sheet for making a pet chew is shown in FIGS. 11-13 which show a single co-extruded sheet 210. The co-extruded sheet has two layers, one layer 214 has a different flavor or a visually distinctive appearance for example, a different color or texture from the other layer 212 of single sheet 210. In one embodiment, the layer 214 may be colored red to simulate a beef jerky and infused with a meat flavor. The flavor additive may again be either artificial or real. The co-extruded sheet can be a square or rectangular shape with edges 220, 222, 224 and 226. One or more active ingredients may be incorporated into either or both layers of the co-extruded sheet to provide a pet chew that contains a dose of the active ingredient(s).

The single sheet 210 as shown in FIG. 11 is then rolled up as shown in FIG. 12 to form a cylinder-shaped edible pet chew 216. The pet chew 216 has end sections 225 that appear from an end view to have a spiral shape 218. The sheet 210 is rolled such that the layer 214 is considered the inner layer. The layer 212 of sheet 210 is positioned at the exterior side of the rolled pet chew 216. Edges 220, 222, 224, and 226 of layer 214 are visible after the rolled pet chew 216 is formed. The edges 220, 222, 224, and 226 of layer 214 form the illusion of beef jerky rolled into the rolled pet chew 216. The cylinder-shaped pet chew 216 is then allowed to dry to harden the composition forming the single sheet 210.

As shown in FIG. 13, an alternate shaped pet chew 316 can be formed to more closely simulate an elongated bone with an elongated middle section 315 also referred to as a diaphysis and opposite simulated epiphyses 317 formed by knots 332 tied at each end section 225 of the cylinder shaped assembly 216 as shown in FIG. 13 before it's hardened. The alternately shaped edible pet chew 316 has the flavored, textured or colored layer 214 with the edge 224 of layer 214 exposed at the epiphyses 317 as well as at the elongated middle section 315.

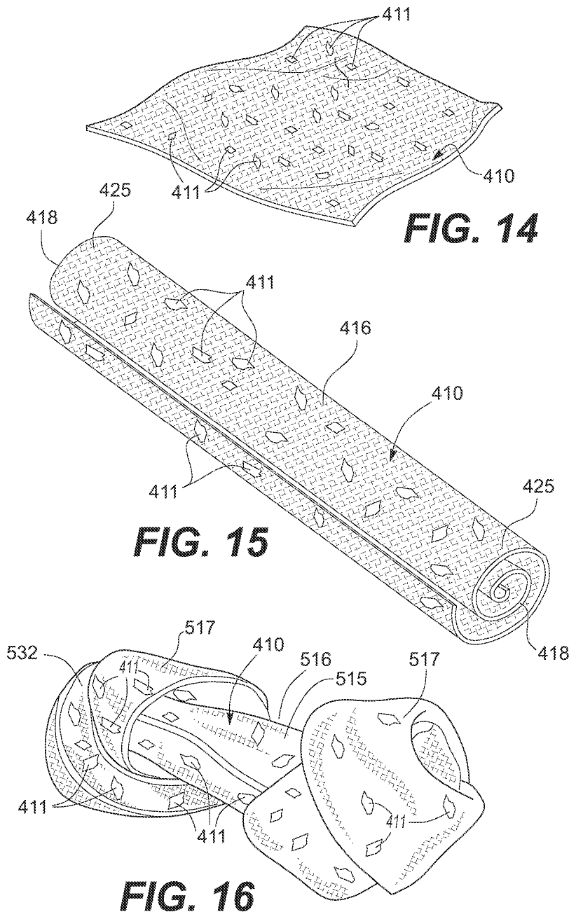

Another alternate embodiment of a single sheet 410 for making a pet chew is shown in FIGS. 14-16 which shows a single extruded sheet 410 with flavor chunks 411 of dried meat or other flavored food stuff embedded therein. The chunks 411 are preferably visible from either side of the single sheet 410. The single sheet 410 as shown in FIG. 14 is then rolled up as shown in FIG. 15 to form a cylinder-shaped edible pet chew 416. The pet chew 416 has rolled end sections 425 that appear from an end view to have a spiral shape 418. The cylinder-shaped pet chew 416 is then allowed to dry to harden the composition forming the single sheet 410.

As shown in FIG. 16, an alternate shaped pet chew 516 can be formed to more closely simulate an elongated bone with an elongated middle section 515 also referred to as a diaphysis and opposite simulated epiphyses 517 formed by knots 532 tied at each end 425 of the cylinder shaped assembly 416 as shown in FIG. 15 before it's hardened. The alternately shaped edible pet chew 516 has the chunks 411 embedded in the sheet 410 and visible at an outer portion of the epiphyses 517as well as therebetween at the exterior side of the elongated middle section 515. Depending on the desired size of the chunks 411, the chunks 411 may either be extruded with the plant-based composition or rolled into the plant-based composition after the plant-based composition is extruded.

In this fashion, by providing an edible pet chew with a hardened and chewable casing made from a plant-based material instead of rawhide, one avoids all the concerns, whether real or perceived, regarding the use of rawhide. Secondly, the plant-based material has inherent nutrition and may be easily provided with added nutritional ingredients such as vitamins and minerals if desired. While a plant-based starch is preferred it is foreseen that a plant-based protein also may be used as a major component of the single sheet.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. An edible dog chew toy, comprising:
a tough chewable material; and
one or more active ingredients that are useful for promoting a calming effect on a dog,
wherein the toy has an appealing taste and scent for the dog throughout substantially the entire chewing life of the chew toy.

2. The toy of claim 1, wherein the tough chewable material comprises a natural rawhide or a synthetic rawhide-type material.

3. The toy of claim 1, wherein the active ingredients include two or more active agents selected from the group consisting of theanine, Relora, SAMe, GABA, ashwagandha, tryptophan, turmeric, Boswellia serrata, ginseng, Methylsulfonylmethane, 5-HTP, Valerian root, Chamomile, Lemon balm, Passion flower, Kavakava, and Ocimum tenuiflorum.

4. The toy of claim 1, wherein the active ingredients include one or more pharmacologically active, but non-psychoactive, cannabinoids.

5. The toy of claim 1, wherein the active ingredients are present in an appropriate dose for the size of the dog.

6. The toy of claim 5, wherein the toy contains CBD and the CBD is present in an amount between 2 and 30 mg per 17.2 kg of body size.

7. The toy of claim 1, wherein the toy comprises a tasty treat member contained in, wrapped in, or otherwise protected by the tough chewable material.

8. The toy of claim 7, wherein the active ingredients are provided with or included in the tough chewable material.

9. The toy of claim 7, wherein the active ingredients are provided with or included in the treat member.

10. The toy of claim 7, wherein the tough chewable material is a rawhide or synthetic rawhide, and the treat member is a tasty coating that is applied to the rawhide material prior to wrapping the rawhide.

11. The toy of claim 7, wherein the treat member is a jerky composition.

12. The toy of claim 1, wherein the active ingredients and flavors that entice the dog are mixed together with suitable ingredients to manufacture the tough chewable material, and the chewable material is then shaped into the edible toy.

13. The toy of claim 1, wherein the tough chewable material comprises a single sheet of a hardened and chewable plant-based material that is initially malleable for folding, rolling or flexing into a final shape.

14. The toy of claim 13, wherein the one or more active ingredients are (i) mixed into the plant-based material; (ii) provided in a coating applied to a sheet of the plant-based material; (iii) provided in a separate layer wrapped with the sheet of the plant-based material; (iv) provided as discrete strips or chunks of an edible material; or (v) combination thereof.

15. The toy of claim 1, wherein the tough chewable material is rolled or folded into a cylinder.

16. The toy of claim 1, wherein the tough chewable material is rolled or folded into a cylinder and one or both ends of the cylinder are then knotted.

17. The toy of claim 1 further comprising packaging containing the toy.

18. A method of calming a dog, comprising the step of: providing the dog with an edible chew toy of claim 1.

19. A method of calming a dog, comprising the steps of:
providing a first bolus of a calming composition that is quickly ingested by the dog; and then
providing the dog with an edible chew toy of claim 1.
